(19) United States
(12) Patent Application Publication
(10) Pub. No.: US 2025/0007625 A1
(43) Pub. Date: Jan. 2, 2025

(54) METHOD, DEVICE, PROCESSOR AND COMPUTER-READABLE STORAGE MEDIUM THEREOF FOR ACHIEVING RECIPROCAL CALIBRATION OF MIMO CHANNEL SIMULATOR

(71) Applicant: TRANSCOM (SHANGHAI) TECHNOLOGY CO., LTD., Shanghai (CN)

(72) Inventors: Wenchong JIANG, Shanghai (CN); Jianhong XIE, Shanghai (CN)

(21) Appl. No.: 18/711,310

(22) PCT Filed: Jul. 21, 2020
(86) PCT No.: PCT/CN2022/106991

§ 371 Date: Jun. 6, 2024

(30) Foreign Application Priority Data
Nov. 18, 2021 (CN) 202111369858.1

(51) Int. Cl. H04B 17/11; H04B 7/0413

(52) U.S. Cl. CPC H04B 17/11; H04B 7/0413

(57) ABSTRACT

The present invention relates to a method for achieving reciprocal calibration of MIMO channel simulators, comprises the following steps: calibrate the power of the transmit and receive channels of the MIMO channel simulator and obtain power calibration data; calculate to get the power P of all channels in the same state, and use it as the baseline value for the current RF link state; calculate the difference between the calibration value and the baseline value for all channels and give the difference to the baseband for processing. The present invention also relates to a device, a processor and a computer-readable storage medium thereof for achieving reciprocal calibration of a MIMO channel simulator. The method, device, processor, and computer-readable storage medium of the present invention for achieving reciprocal calibration of a MIMO channel simulator are employed to propose an inter-channel phase calibration scheme for a large-scale MIMO system in a convenient and fast way, which greatly reduces the calibration workload. The data processing of the present invention improves the accuracy of the power, substantially reduces the phase error due to different RF configurations, and improves the interoperability of the base stations.

### CROSS-REFERENCE TO RELATED APPLICATION

This application claims priority of Chinese Invention patent application No. 202111369858.1 filed Nov. 18, 2021, which is incorporated herein by reference.

### FIELD OF TECHNOLOGY

The present invention relates to the field of wireless communication equipment, in particular to the field of massive MIMO systems, specifically, it refers to a method, device, processor and computer-readable storage medium thereof for achieving reciprocal calibration of MIMO channel simulator.

### DESCRIPTION OF RELATED ARTS

Massive MIMO is one of the key technologies in the 5G era, and massive MIMO systems can make full use of beam fouling techniques, after algorithmic processing, a narrower beam can be formed, so that the antenna radiation angle can be concentrated in a defined spatial area, thus concentrating the main transmit power in the destination range, even if the transmit power of the base station is reduced, it can also meet the requirements of high-quality communication, thus improving the energy efficiency of the radio frequency (RF) transmission link between the base station and the user. It has been shown that the more antennas at the base station end, the lower the transmit power of the wireless, regardless of whether the ideal channel state is obtainable or not. Therefore, massive MIMO systems can substantially improve the energy efficiency of wireless communication systems.

In the 5G TDD communication system, the base station side carries out the design of downlink channel precoding based on the estimated uplink channel state information (CSI), which serves multiple UEs on the same time and frequency resources based on the reciprocity of uplink and downlink channels. However, in practical communication only the airborne wireless channel satisfies reciprocity, and a complete communication channel contains not only the airborne wireless channel, but also the RF hardware circuitry. For terminals, power mismatch can cause some degree of deterioration in system performance, while for base stations, both power and phase mismatch can cause significant degradation in system performance.

In the 5G master device and terminal R&D test scenario, the base station, MIMO channel simulator, and terminal are connected as shown in FIG. 1. A complete downlink signal transmission process: the signal is output from the base station, the antenna port of the base station is connected to the port of the MIMO channel simulator, the signal arrives in the MIMO channel simulator, after the signal is processed by the MIMO channel simulator, the signal is output from the MIMO channel simulator, and then finally received by the terminal antenna and arrives at the terminal.

When the signal is transmitted in the RF channel of the MIMO channel simulator, limited by the process error of the RF link device of the MIMO channel simulator, device consistency error and other conditions, the signal consistency of the MIMO channel simulator output from the MIMO channel simulator is relatively poor in the state of the uncalibrated MIMO channel simulator, which will cause some damage to the entire channel interoperability, which will make the channel interoperability impaired that damages the performance of the overall system. At this point, it is necessary to calibrate the RF link of the MIMO channel simulator to improve the overall consistency of the MIMO channel simulator, the base station and the terminal, and then improve the performance of the entire system.

In traditional calibration schemes, there is no link between power and phase data, and it is the power error and phase that are directly compensated for. This brings a lot of disadvantages and does not take into account that MIMO channel simulators have different RF links when the power is not the same, which leads to incorrect phasing of the RF link compensation at that power point. At the same time, if we want to avoid this problem, then we need to calibrate more RF link states, more calibration points, more work, and more time consuming. The present invention achieves the goal of phase consistency by calibrating fewer points than traditional schemes. The present invention also introduces the least squares method, which also minimizes the error, and in the present invention, baseband compensation for residual error is again used, whereby the difference between each channel is compensated by the baseband, so that each channel is unified on the RF link, which is more conducive to improving the interoperability of the MIMO channel simulator.

### SUMMARY OF THE INVENTION

It is an object of the present invention to overcome the drawbacks of the above-mentioned prior art, and to provide a method, device, processor and computer-readable storage medium thereof for achieving reciprocal calibration of MIMO channel simulators that satisfy the requirements of high accuracy, simplicity of operation, and wider range of applicability.

In order to achieve the above objectives, the method, device, processor and computer-readable storage medium thereof of the present invention for achieving reciprocal calibration of MIMO channel simulators are as follows:

The method for achieving reciprocal calibration of MIMO channel simulators, the main feature of which is that the said method comprises following steps:
(1) calibrate the power of the transmit and receive channels of the MIMO channel simulator and obtain power calibration data;
(2) calculate to get the power P of all channels in the same state, and use it as the baseline value for the current RF link state;
(3) calculate the difference between the calibration value and the baseline value for all channels and give the difference to the baseband for processing.

Preferably, the power P of all channels in the same state is calculated in step (2) described as: calculate the power P of all channels in the same state according to the following equation:

$$∈ = \sum {( P - Pi )}^{2} ;$$

where Pᵢ is the power of all channels in the RF state, and ∈ is the total error of all channels.

Preferably, the said step (2) obtains the power P of all channels in the same state by least squares calculation.

The device for achieving reciprocal calibration of MIMO channel simulators, the main feature of which is that the said device comprises:
processor, configured to execute computer-executable instructions;
memory, storing one or more computer-executable instructions, when the said computer-executable instructions are executed by the said processor, various steps for realizing the method for achieving reciprocal calibration of MIMO channel simulators as claimed in above-described.

The processor for achieving reciprocal calibration of MIMO channel simulators, the main feature of which is that the said processor being configured to execute computer-executable instructions, when the said processor being configured to execute computer-executable instructions, various steps for realizing the method for achieving reciprocal calibration of MIMO channel simulators as claimed in above-described.

The computer-readable storage medium, the main feature of which is that the computer program stored on it, and the said computer program may be executed by a processor to implement the various steps for realizing the method for achieving reciprocal calibration of MIMO channel simulators as claimed in above-described.

The method, device, processor, and computer-readable storage medium of the present invention for achieving reciprocal calibration of a MIMO channel simulator are employed to propose an inter-channel phase calibration scheme for a large-scale MIMO system in a convenient and fast way, which greatly reduces the calibration workload. The data processing of the present invention improves the accuracy of the power, substantially reduces the phase error due to different RF configurations, and improves the interoperability of the base stations.

### BRIEF DESCRIPTION OF THE DRAWINGS

FIG. 1 shows a schematic diagram of a base station, a MIMO channel simulator and a terminal connected to the device of the present invention for achieving reciprocal calibration of a MIMO channel simulator.

FIG. 2 shows a flowchart of the method of the present invention for achieving reciprocity calibration of a MIMO channel simulator.

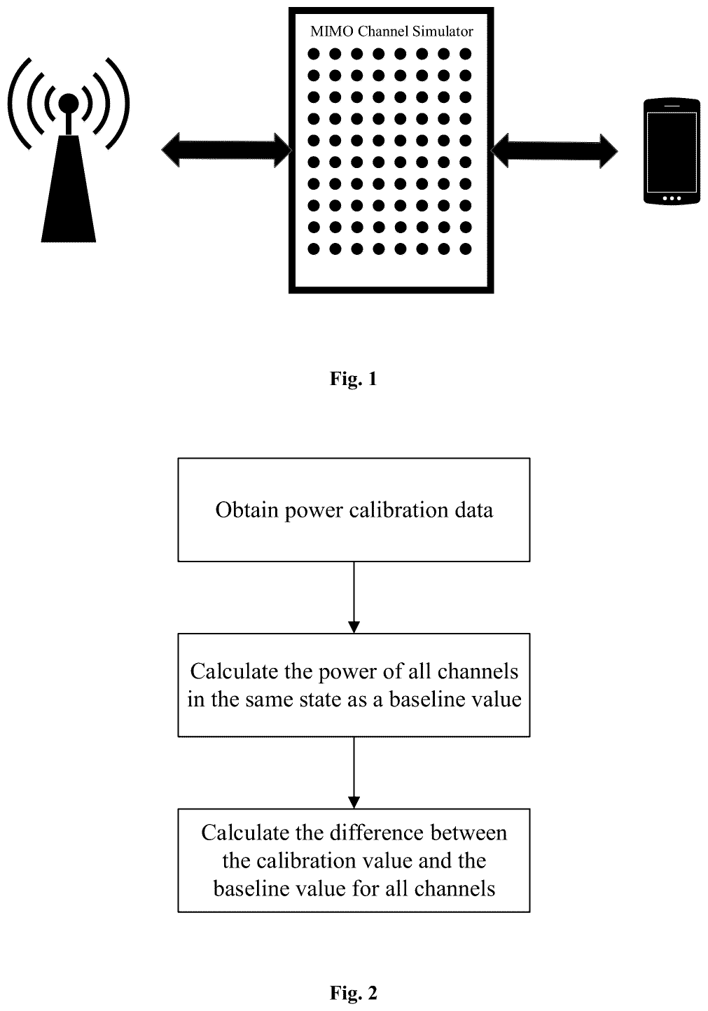

### DETAILED DESCRIPTION OF THE PREFERRED EMBODIMENT

In order to be able to understand the technical content of the present invention more clearly, is further exemplified by the following detailed description of embodiments.

The method for achieving reciprocal calibration of MIMO channel simulators of the present invention, wherein the method comprises the following steps:
(1) calibrate the power of the transmit and receive channels of the MIMO channel simulator and obtain power calibration data;
(2) calculate to get the power P of all channels in the same state, and use it as the baseline value for the current RF link state;
(3) calculate the difference between the calibration value and the baseline value for all channels and give the difference to the baseband for processing.

As a preferred embodiment of the present invention, the power P of all channels in the same state is calculated in step (2) described as:

calculate the power P of all channels in the same state according to the following equation:

$$∈ = \sum {( P - Pi )}^{2} ;$$

where Pᵢ is the power of all channels in the RF state, and ∈ is the total error of all channels.

As a preferred embodiment of the present invention, the said step (2) obtains the power P of all channels in the same state by least squares calculation.

This device for achieving reciprocal calibration of a MIMO channel simulator of the present invention, wherein said device comprises:
processor, configured to execute computer-executable instructions;
memory, storing one or more computer-executable instructions, when the said computer-executable instructions are executed by the said processor, various steps for realizing the method for achieving reciprocal calibration of MIMO channel simulators as claimed in above-described.

This processor for achieving reciprocal calibration of MIMO channel simulator of the present invention, the main feature of which is that the said processor being configured to execute computer-executable instructions, when the said processor being configured to execute computer-executable instructions, various steps for realizing the method for achieving reciprocal calibration of MIMO channel simulators as claimed in above-described.

This computer-readable storage medium of the present invention, the main feature of which is that the computer program stored on it, and the said computer program may be executed by a processor to implement the various steps for realizing the method for achieving reciprocal calibration of MIMO channel simulators as claimed in above-described.

Due to the process variability of the RF devices of the MIMO channel simulator, it is not possible to achieve perfect phase alignment for all channels, we can only reduce the problem of phase inconsistency between the transmitter and receiver of the MIMO channel simulator by calibrating the transmitter RF link and the receiver RF link, respectively, and preprocessing the calibration data so that the phase error of all channels of the MIMO channel simulator can be controlled within a certain range.

For signals transmitted in a MIMO channel simulator, the phase difference is mainly caused by the inconsistency of the RF link in the MIMO channel simulator. The signals are transmitted through different RF channels in the MIMO channel simulator, passing through different RF devices on the RF channels, including amplifiers, attenuators, filters, etc. In MIMO channel simulators, the main cause of phase differences between channels is the state of amplifier and attenuator configurations on the RF link, i.e., the signal transmission path. The different states of these devices correspond to different power levels. When the configured power is different, the RF device states on each RF channel of the MIMO channel simulator are configured differently and thus the signal transmission paths are different. In order to minimize the effect on the phase due to the switching configuration, the different states need to be calibrated.

Depending on the real-world MIMO scenario, multiple antennas will need to correspond to multiple RF channels of the MIMO channel simulator. After calibration, there are also slight differences in power between different channels and in different configuration states. When configuring power, different channels may be in different RF states, which leads to poor channel reciprocity.

The present invention proposes an inter-channel calibration method that considers different channels with the same RF link as one case, and at the same time, the power values of all channels in the same state are processed using the least squares method to obtain a value P. The data P is recorded using the least squares method to process the calibration data of the different channels, which is also able to effectively reduce the error. The same state includes the same frequency point, the same switch state, and the same transmission path of the signal in the MIMO channel simulator, which minimizes the phase difference between the channels, and also reduces the calibration workload, which is only required to calibrate the state of a number of switches in the channel to achieve the calibration of the full dynamic range of the RF channel.

Finally, the calibration value is differenced from P, the difference is recorded, and the difference is given to the baseband for processing, so that each channel is unified in the RF link at the same frequency and the same power, avoiding the effects brought about by the inconsistency of the RF channels. After processing all the data in this way, we have the calibration values for all channels. In this case, the RF configuration is the same between different channels at the same power and frequency, differing only in the value of the inherent error of the RF path of the MIMO channel simulator due to the constraints of coherence, this error value, since it is processed on the baseband, has no effect on the phase and achieves a high calibration accuracy. In this way, the performance of the base station terminal can be fully enhanced by ensuring the reciprocity between the transmitter and receiver RF paths on the MIMO channel simulator.

Specific embodiments of the invention include the following steps:

1. It is necessary to carry out the power calibration work of the transmit channel and receive channel of the MIMO channel simulator to obtain the power calibration data. Taking the transmit channel as an example, some of the calibration data are shown in Table 1. In the table, A1, A2, and A3 represent the switches for different RF amplifiers or attenuators on each RF channel of the MIMO channel simulator, with 1 being on and 0 being off. At this point, the switch configurations of A1, A2, and A3 in the table represent one state of the MIMO channel simulator transmitter RF link.

TABLE 1

| Channel | | | | | |
|---|---|---|---|---|---|
| Number | Power p | A1 | A2 | A3 | Diff |
| 1 | 4.05891 | 1 | 1 | 1 | 0 |
| 2 | 3.60583 | 1 | 1 | 1 | 0 |
| 3 | 4.65404 | 1 | 1 | 1 | 0 |
| 4 | 4.17045 | 1 | 1 | 1 | 0 |
| 5 | 3.98855 | 1 | 1 | 1 | 0 |
| 6 | 4.51223 | 1 | 1 | 1 | 0 |
| 7 | 5.36639 | 1 | 1 | 1 | 0 |
| . . . | . . . | 1 | 1 | 1 | 0 |
| m | 4.99682 | 1 | 1 | 1 | 0 |

2. Use the least squares method to find the power P of all channels at unity.

Suppose: the power of all channels at this time in RF state is P1, P2 . . . Pi. Then the total error of all channels can be expressed as: ∈=Σ(P−Pᵢ)∧2.

When ∈ is the smallest, i.e., the error is the smallest, the desired P is obtained through the computation, which, at this point, is stored as the baseline value for the current RF link state. Traversing all RF link states completes the data processing for all channels. Some of the data is shown in Table 2, i.e., the RF link calibration data based on the data processing of each channel.

TABLE 2

| Channel | | | | | |
|---|---|---|---|---|---|
| Number | Power p | A1 | A2 | A3 | Diff |
| 1 | 4.05891 | 1 | 1 | 1 | 0 |
| 2 | 3.60583 | 1 | 1 | 1 | 0 |
| 3 | 4.65404 | 1 | 1 | 1 | 0 |
| 4 | 4.17045 | 1 | 1 | 1 | 0 |
| 5 | 3.98855 | 1 | 1 | 1 | 0 |
| 6 | 4.51223 | 1 | 1 | 1 | 0 |
| 7 | 5.36639 | 1 | 1 | 1 | 0 |
| . . . | . . . | 1 | 1 | 1 | 0 |
| m | 4.99682 | 1 | 1 | 1 | 0 |
| Baseline | 4.31867 | 1 | 1 | 1 | 0 |
| Value | | | | | |

3. Based on the baseline value obtained, the calibration value in each table is differed from the baseline value, and the difference value obtained is stored to the Diff column of the table, and this value is finally acted on the baseband. The data is shown in Table 3, i.e., the RF link calibration data for each channel after processing based on the baseline values.

TABLE 3

| Channel | | | | | |
|---|---|---|---|---|---|
| Number | Power p | A1 | A2 | A3 | Diff |
| 1 | 4.31867 | 1 | 1 | 1 | 0.25976 |
| 2 | 4.31867 | 1 | 1 | 1 | 0.71284 |
| 3 | 4.31867 | 1 | 1 | 1 | −0.33537 |
| 4 | 4.31867 | 1 | 1 | 1 | 0.14822 |
| 5 | 4.31867 | 1 | 1 | 1 | 0.33012 |
| 6 | 4.31867 | 1 | 1 | 1 | −0.19356 |
| 7 | 4.31867 | 1 | 1 | 1 | −1.04772 |
| . . . | . . . | 1 | 1 | 1 | . . . |
| m | 4.31867 | 1 | 1 | 1 | −0.67815 |
| Baseline | 4.31867 | 1 | 1 | 1 | 0 |
| Value | | | | | |

When embodiments of the present invention are tested directly using unprocessed calibration data, the phase data is very messy, without consistency or regularity, and the test data is shown in Table 4, calculating from the data in the table we can get that the phase error value has reached 22.2, which is completely unusable in a MIMO system. The RF link phase data for each channel after bringing in the unprocessed calibration data is shown in Table 4.

TABLE 4

| Cable Number | Phase Value | Cable Number | Phase Value |
|---|---|---|---|
| 1 | −30 | 9 | −36.4 |
| 2 | −37.5 | 10 | −45.6 |
| 3 | −39.3 | 11 | −23.4 |
| 4 | −40.8 | 12 | −33.5 |
| 5 | −39.2 | 13 | −32.6 |
| 6 | −29.6 | 14 | −30.5 |
| 7 | −27.8 | 15 | −39.7 |
| 8 | −32.4 | 16 | −31.6 |

| | |
|---|---|
| Phase Error | 22.2 |

When the data is processed as described above and then tested, we get the following test results. Through the data in the table (part of the data), we can see that the phase error has been within ±3 degrees, and the effect has been significantly improved. The RF link phase data for each channel after processing based on the baseline value is shown in Table 5.

TABLE 5

| Cable Number | Phase Value | Cable Number | Phase Value |
|---|---|---|---|
| 1 | −33 | 9 | −36.1 |
| 2 | −32.8 | 10 | −33.6 |
| 3 | −36.2 | 11 | −36.2 |
| 4 | −34.5 | 12 | −34.1 |
| 5 | −37.4 | 13 | −35.4 |
| 6 | −33.6 | 14 | −32.2 |
| 7 | −35.7 | 15 | −36 |
| 8 | −33.3 | 16 | −32.6 |

| | |
|---|---|
| Phase Error | 5.2 |

Specific embodiments of this embodiment can be found in the relevant descriptions in the above embodiments and will not be repeated here.

It is to be understood that the same or similar portions of the above embodiments may be cross-referenced, and what is not described in detail in some embodiments may be seen as the same or similar in other embodiments.

It should be noted that in the description of the present invention, the terms “first”, “second”, etc. are used for descriptive purposes only and are not to be understood as indicating or implying relative importance. Furthermore, in the description of the present invention, unless otherwise indicated, “plurality” means at least two.

Any process or method description depicted in the flowchart or otherwise described herein may be understood to represent a module, fragment, or portion of code comprising one or more executable instructions for implementing the steps of a particular logical function or process, and that the scope of the preferred embodiments of the present invention includes additional implementations, which may be, in no particular order as shown or discussed, including performing functions in a substantially simultaneous manner or in reverse order, according to the functions involved, should be understood by those skilled in the art to which embodiments of the present invention belong.

It should be understood that various parts of the invention may be implemented with hardware, software, firmware, or combinations thereof. In the above embodiments, a plurality of steps or methods may be implemented with software or firmware stored in memory and executed by a suitable instruction execution device. For example, if implemented in hardware, as in another embodiment, it may be implemented with any of the following techniques known in the art or combinations thereof: discrete logic circuits having logic gates for implementing logic functions on data signals, special-purpose integrated circuits having suitably combinational logic gates, programmable gate arrays (PGA), field-programmable gate arrays (FPGA), and the like.

One of ordinary skill in the art can appreciate that all or some of the steps carried out to realize the method of the above embodiments can be accomplished by instructing the associated hardware by means of a program, which can be stored in a computer-readable storage medium that, when executed, comprises one of the steps of the method embodiments or a combination thereof.

Furthermore, the functional units in various embodiments of the present invention may be integrated in a single processing module, or the individual units may be physically present separately, or two or more units may be integrated in a single module. The integrated modules described above may be implemented either in the form of hardware or in the form of software function modules. The integrated modules may also be stored in a computer-readable storage medium if they are implemented as software function modules and sold or used as stand-alone products.

The storage media mentioned above may be read-only memories, disks or CD, etc.

In the description of this specification, reference to the terms “an embodiment”, “some embodiments”, “example”, “specific example”, or “embodiment” means that a specific feature, structure, material, or characteristic described in conjunction with the embodiment or example is included in at least one embodiment or example of the present invention. In this specification, schematic representations of the above terms do not necessarily refer to the same embodiments or examples. Moreover, specific features, structures, materials, or characteristics described may be combined in any one or more embodiments or examples in a suitable manner.

The method, device, processor, and computer-readable storage medium of the present invention for achieving reciprocal calibration of a MIMO channel simulator are employed to propose an inter-channel phase calibration scheme for a large-scale MIMO system in a convenient and fast way, which greatly reduces the calibration workload. The data processing of the present invention improves the accuracy of the power, substantially reduces the phase error due to different RF configurations, and improves the interoperability of the base stations.

In this specification, the present invention has been described with the reference to its specific embodiments. However, it is obvious still may be made without departing from the spirit and scope of the present invention, various modifications and transformation. Accordingly, the specification and drawings should be considered as illustrative rather than restrictive.

1. A method for achieving reciprocal calibration of MIMO channel simulators, characterized in that, the method comprises the following steps:
(1) calibrate the power of the transmit and receive channels of the MIMO channel simulator and obtain power calibration data;
(2) calculate to get the power P of all channels in the same state, and use it as the baseline value for the current RF link state;
(3) calculate the difference between the calibration value and the baseline value for all channels and give the difference to the baseband for processing.

2. The method for achieving reciprocal calibration of MIMO channel simulators according to claim 1, characterized in that, the power P of all channels in the same state is calculated in step (2) described as:
calculate the power P of all channels in the same state according to the following equation:
$$∈ = \sum {( P - Pi )}^{2} ;$$
where Pi is the power of all channels in the RF state, and ∈ is the total error of all channels.

3. The method for achieving reciprocal calibration of MIMO channel simulators according to claim 1, characterized in that, the said step (2) obtains the power P of all channels in the same state by least squares calculation.

4. A device for achieving reciprocal calibration of MIMO channel simulators, characterized in that, the device comprises:
processor, configured to execute computer-executable instructions;
memory, storing one or more computer-executable instructions, when the said computer-executable instructions are executed by the said processor, various steps for realizing the method for achieving reciprocal calibration of MIMO channel simulators as claimed in claim 1.

5. A processor for achieving reciprocal calibration of MIMO channel simulators, characterized in that, the processor being configured to execute computer-executable instructions, when the said processor being configured to execute computer-executable instructions, various steps for realizing the method for achieving reciprocal calibration of MIMO channel simulators as claimed in claim 1.

6. A computer-readable storage medium, characterized in that, which has a computer program stored on it, the said computer program may be executed by a processor to implement the various steps for realizing the method for achieving reciprocal calibration of MIMO channel simulators as claimed in claim 1.
